(19) United States
(12) Patent Application Publication
(10) Pub. No.: US 2015/0242892 A1
(43) Pub. Date: Aug. 27, 2015

(54) REAL-TIME, USER-SPECIFIC OFFER GENERATION AND OPTIMIZATION

(71) Applicant: Seth Priebatsch, Boston, MA (US)

(72) Inventor: Seth Priebatsch, Boston, MA (US)

(21) Appl. No.: 14/189,482

(22) Filed: Feb. 25, 2014

(51) Int. Cl. G06Q 30/02

(52) U.S. Cl. CPC G06Q 30/0255

(57) ABSTRACT

Representative embodiments of a method of electronically providing a consumer with promotional offers for goods or services include, at a server, electronically storing, in a database, multiple records, each having data identifying one or more items and one or more trigger rules; electronically receiving notification indicative of an action by a consumer, the notification including data identifying one or more items; identifying one or more promotion offerors by querying the database using the received data; and if the received data satisfies a trigger rule, causing transmission of data comprising item identification to the identified promotion offeror(s).

### FIELD OF THE INVENTION

In various embodiments, the present invention relates generally to systems and methods for generating customized promotional offers for consumers in real-time.

### BACKGROUND

Merchants and suppliers often use promotional campaigns when marketing their products, to provide consumers or business customers with discounts or other incentives to purchase goods or services. Promotional campaigns include coupons, price reductions, buy-one-get-one-free promotions, contests, and the like. The objective of a sales promotion is to induce consumers to test or purchase products. Ideally, these efforts are directed toward the most profitable prospects: “high-yield” consumers most like to buy, and to do so in quantity. For example, a merchant might not want to waste a promotional offer on someone likely to try the product once, if at all, and never repeat the purchase; rather, merchants target consumers who exhibit habitual behavior.

Conventionally, merchants try to target consumers who fit key demographic and/or psychographic criteria that are indicative of a predisposition toward their products. Demographics can be basic characteristics such as sex, age, education and occupation, while psychographics can indicate a person's preferences and intentions. For example, a merchant may target women of age 25 to 45 for a new cosmetic product by placing a promotional offer, such as a coupon, in a women's magazine. Ultimately, however, the merchant may find the demographic to have been substantially over inclusive, reaching many women, and even men, who are unlikely to become repeat customers. Additionally, although psychographics are helpful in targeting consumers of products such as cigarettes, beer and cosmetics, the targeted consumers may not correlate well with demographic characteristics.

Another targeting strategy relies on coarse and unfocused marketing channels (such as media advertisements). Because this approach does not target individuals specifically, analytics at the individual level cannot be exploited; as a result, targeting effectiveness is quite limited. In addition, the coarse advertisements are generally expensive and consumers may get annoyed about constantly receiving advertisements of no interest to them.

These marketing limitations are changing rapidly, in particular because the advent of the Internet has provided merchants with new channels for reaching consumers and providing information, advertising, and offers related to their products or services. The available targets, however, are typically limited to consumers who have registered accounts with the merchant or have purchased items from the merchant in the past. Although the merchant may place online advertisements on a web page via a search engine, again, the unfocused targeting is limited in effectiveness and may sometimes repel the consumer.

Consequently, there is a need for an approach that provides effective delivery of promotional campaigns to the consumer on an individual level, thereby resulting in fewer wasted communications.

### SUMMARY

In various embodiments, the present invention provides an approach that effectively delivers promotions offered by a merchant (or any party) to consumers who may be interested in the offeror's products. As the consumer physically or electronically examines items of interest, for example, the identities of these items may be communicated in real-time to interested offer providers, who may thereupon offer a promotion to the consumer based on the examined items and/or other data. For example, the consumer may examine physical items displayed in a store by scanning their barcodes (or the items themselves) using a smart phone, and a running process (“app”) on the smart phone may transmit data identifying the item to offer providers (either directly or, as described below, via a promotion server that targets data transmissions to interested offer providers). Alternatively, the item data may be supplied to offer providers at another point, e.g., when the consumer actually makes a purchase. In some embodiments, the offer provider specifies promotional or other targeting criteria (e.g., consumer's demographics or transactional history) to identify recipients of a promotion and/or notifications it wishes to receive. These criteria are stored in a promotions database.

Data identifying the consumer's examined or purchased items is provided (e.g., by the consumer's smart phone or by a point-of-sale (POS) terminal upon checkout) to the promotion server, along with, in some embodiments, other data such as the current weather, the consumer's geographic location, etc. The promotions database may associate other transactional and non-transactional data with the consumer (e.g., demographic characteristics, past purchasing history) and supply this data to offer providers along with item-level data. In various embodiments, the offer providers themselves dictate, in registering or updating their accounts with the promotion server, the data they wish to receive upon the occurrence of triggering events that they specify in order to determine the timing and nature of their offers. Demographic data, for example, may influence the amount of the offer or whether it is even provided to a particular consumer; thus, two consumers may scan the same item in the same store, but due to differences in demographic characteristics, it may be that only one of those consumers will satisfy the criteria supplied by a particular offer provider. That offer provider, in turn, will only learn of the triggering event—in this case, the consumer's scan of the item—in the matching case. And again, while some offer providers may select consumer scanning of an item as a triggering event, others may prefer not to send offers until the consumer actually pays for purchases, in which case checkout is the triggering event.

The offer provider may be the merchant itself, e.g., so that it may notify interested customers of promotions associated with items they examine on store shelves, or a third-party provider of promotions that communicates offers, directly or via the promotion server, to consumers in response to information received from the promotion server upon a triggering event. Either way, offer providers may thus control the terms and timing of their promotions in order to accurately reflect, for example, the “value” of the consumer (e.g., the likelihood that he will redeem the promotion and become a repeat customer) as well as the current economics of product promotion (e.g., the real-time value of incentivizing the purchase of a particular product).

In some embodiments, rather than notifying offer providers of an action taken by the consumer, the promotion server itself transmits one or more promotions to the consumer on behalf of a promotion provider when the consumer's action and the item associated therewith satisfy criteria stored in the promotions database. For example, offer providers may register promotions with the promotion server and specify the criteria associated with their transmission. The promotions themselves need not be stored on the server, but may instead reside with the offer provider (which may change the terms at will, in real-time). For example, the promotions database may store an Internet address associated with an offer, and when its criteria are matched, the server retrieves the most current version of the offer using the Internet address, thereupon providing this to the consumer whose action caused the match to occur.

In still another embodiment, occurrence of a triggering event results in auction among offer providers, i.e., upon receiving notification of the consumer inquiry and the additional data they have requested, offer providers may place bids for the privilege of providing an offer to the consumer. One or more promotional offers provided by the auction winner(s) are transmitted to the consumer. Decisions about how many and which offers are provided to the consumer—i.e., the rules of the auction—may be based on, for example, the discount amount, any item-level or seller-level conflict between the offers (e.g., offers for the same type of items from competing merchants), the likelihood of offer redemption, the likelihood of affecting the consumer's future purchases, and/or benefits accruing to the consumer and/or the offer provider. In addition, the offers may be ranked based on, for example, the geographic proximity between the consumer and the offer providers, the popularity of the offers, the ratings and reviews of the offer providers by other consumers, discounted amounts, and/or the frequencies with which the consumer's connections on social media sites have mentioned the offer providers; the ranking rules may be determined by the offer provider or, in some embodiments, the consumer. Accordingly, the current invention provides consumers with customized deals that are more likely to be of interest and the offer provider with effective consumer targeting, thereby increased sales traffic.

Accordingly, in one aspect, the invention pertains to a method of electronically providing a consumer with promotional offers for goods or services. In various embodiments, the method includes steps of, at a server, electronically storing, in a database, multiple records each including data identifying one or more items and one or more trigger rules; electronically receiving notification indicative of an action by a consumer, the notification including data identifying one or more items; identifying one or more promotion offerors by querying the database using the received data; and if the received data satisfies a trigger rule, causing transmission of data having item identification to the identified promotion offeror(s). The action performed by the consumer may be scanning an item, acquiring an image, a barcode, a universal product code, an identifier, and/or a keyword relating to the item using a mobile phone of the consumer. In one implementation, the action includes presentation, by the consumer, of the item for checkout.

The method may include transmitting, by the identified promotion offeror(s), one or more promotions to a mobile device associated with the consumer; the promotion(s) may be redeemable via the mobile device. The method may further include identifying the consumer based on information associated with the mobile device and providing data characterizing the consumer to the identified promotion offeror(s).

In some embodiments, the data identifying at least one item includes non-transactional information. The non-transactional information may include (i) weather conditions, (ii) geographic proximity of the consumer to a location specified in advance by the identified promotion offeror(s), and/or (iii) demographic information characterizing the consumer. In addition, the non-transactional information may include information associated with a mobile device of the consumer, in which case the device information may include a cellular phone number, a cellular telephone electronic serial number (ESN), an International Mobile Equipment Identity (IMEI) code, and/or an 802.15 (Bluetooth) MAC address. In various embodiments, the data having item identification further includes transactional information. The transactional information may include a past purchasing history of the consumer.

In various embodiments, the method includes receiving, at the server, bids from multiple promotion offerors following transmission of the data to them. The method further includes identifying a winning bid and transmitting one or more offers associated therewith to a mobile device associated with the consumer. The offer(s) may be transmitted by the server or by the source of the winning bid.

In another aspect, the invention relates to a method of electronically providing a consumer with promotional offers for goods or services. In various embodiments, the method includes steps of, at a server, electronically storing, in a database, multiple records each having data identifying one or more items, one or more trigger rules, and one or more promotions; electronically receiving notification indicative of an action by a consumer, the notification including data identifying one or more items; identifying one or more promotions by querying the database using the received data; and if the received data satisfies a trigger rule, causing electronic transmission to the consumer of the identified promotion(s). In one implementation, the promotion is transmitted to a mobile device of the consumer and is redeemable via the mobile device.

In various embodiments, the method includes, upon identifying the promotions, assigning each of the promotions a ranking score and transmitting only some of the promotions based on the ranking scores thereof. The ranking scores may be assigned based on (i) a discount amount, (ii) geographic proximity between the consumer and offer providers, (iii) a likelihood of offer redemption, (iv) a likelihood of affecting the consumer's future purchasing behavior, (v) popularity of the offers, (vi) ratings and reviews of offer providers by other consumers, and/or (vii) frequencies that connections of the consumer on social media sites have mentioned offer providers.

The method may include classifying the trigger rules and records associated with the consumers into multiple classes; classifying data identifying the item into one or more classes; and computationally determining applicability of the trigger rules based at least in part on the identified class(es) of data. In addition, the method may further include directing the consumer to an offer provider's web page associated with the transmitted promotion; adding the item of interest in a shopping cart; and entering a promotion code on the offer provider's web page.

Another aspect of the invention relates to a server for electronically providing a consumer with promotional offers for goods or services. In various embodiments, the server includes a database for storing multiple records, each having data identifying one or more items and one or more trigger rules; a communication module; and a processor. In one implementation, the processor is configured to electronically receive, via the communication module from a merchant device, notification indicative of an action by a consumer, where the notification includes data identifying one or more items; computationally identify one or more promotion offerors by querying the database using the received data; and if the received data satisfies a trigger rule, cause transmission of data having item identification to the identified promotion offeror(s).

The processor may be configured to transmit one or more promotions to a mobile device associated with the consumer. In addition, the processor may be configured to identify the consumer based on information associated with the mobile device and provide data characterizing the consumer to the identified promotion offeror(s). In one embodiment, the processor is further configured to electronically receive bids from multiple promotion offerors following transmission of the data to them. The processor is configured to then computationally identify a winning bid and transmit one or more offers associated therewith to a mobile device associated with the consumer.

In yet another aspect, the invention pertains to a server for electronically providing a consumer with promotional offers for goods or services. In various embodiments, the server includes a database for storing multiple records, each having data identifying one or more items, one or more trigger rules, and one or more promotions; a communication module; and a processor. In some embodiments, the processor is configured to: electronically receive, via the communication module from a merchant device, notification indicative of an action by a consumer, the notification including data identifying one or more items; computationally identify one or more promotions by querying the database using the received data; and if the received data satisfies a trigger rule, cause electronic transmission to the consumer of the identified promotion(s).

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIGS. 2A and 2B are block diagrams of an exemplary mobile device and campaign processor, respectively, in accordance with an embodiment of the invention;

FIG. 3 is a block diagram illustrating an approach for providing a promotional offer to a consumer in accordance with an embodiment of the invention; and

FIGS. 4A-4C are workflow diagrams that illustrate providing a promotional offer to the consumer in accordance with various embodiments of the invention.

### DETAILED DESCRIPTION

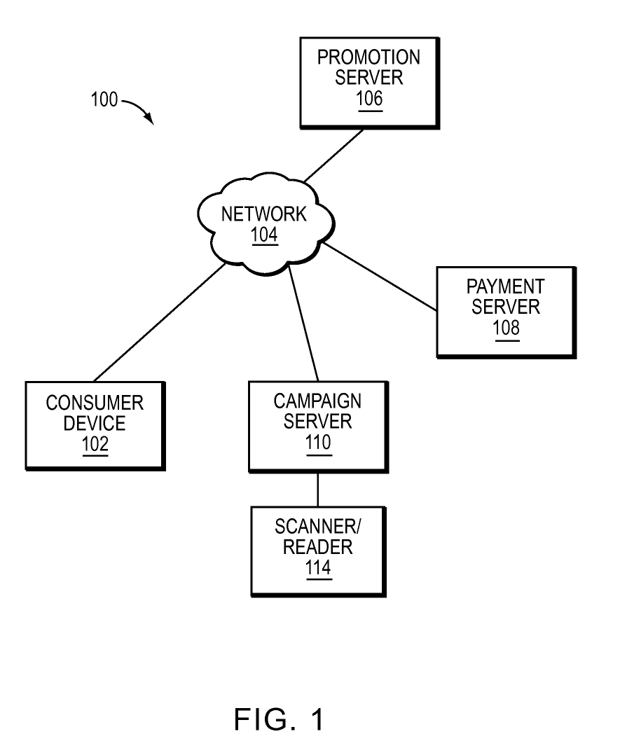

Refer first to FIG. 1, which depicts an exemplary mobile-payment transaction network 100 including a consumer device (e.g., a mobile device) 102 linked to other systems via a network 104 that supports wired, wireless, or any two-way communication (e.g., a cellular telephone network, the Internet, or any wide-area network or combination of networks capable of supporting point-to-point data transfer and communication). The network 104 connects various devices, including a promotion server 106, a payment processor 108, and one or more campaign servers 110 as described in greater detail below. Each campaign server 110 is associated with an interested offer provider, such as a merchant who offers goods or services for sale to the consumer device 102 or a third-party provider (e.g., the product manufacturer, advertiser, marketplace participant upstream from the merchant, or any party interested in providing promotional offers to the consumer). In one embodiment, the campaign server 110 is a merchant point-of-sale (POS) system (e.g., an electronic cash register) that connects to a code reader or scanner (hereafter “reader”) 114. The reader 114 may be mobile or physically associated with the campaign server 110 and may be capable of reading and/or decoding a payment token presented as, for example, a barcode, a radiofrequency identification (RFID) code, or a “Quick Response” (QR) code, and/or receiving signals, such as NFC signals, audio signals, or infrared signals transmitted from the consumer's device 102. The campaign server 110 may establish promotional guidelines that specify promotional or other targeting criteria (e.g., consumer's demographics or transactional history) to identify recipients of a specific promotion and/or notifications the offer provider wishes to receive when triggering events occur; these promotional guidelines are stored in a promotions database in the promotion server 106. Prior to a purchase, the consumer may examine an item of interest and use his mobile device 102 to obtain information associated therewith. For example, the consumer may acquire an image of the item, scan an identifier (e.g., a barcode or a universal product code) located on the item, and/or enter an identifier or keyword relating to the item. This data related to the item is then transmitted from the mobile device 102 to the promotion server 106 or, in some embodiments, directly to the campaign server 110. Alternatively, the consumer may simply search the Internet for the item of interest using the mobile device 102; an application installed on the device 102 may then monitor the websites and/or items that the consumer browses and transmits this information to the promotion server 106. In some embodiments, the data related to the item is submitted to the promotion server 106 by a merchant POS terminal, rather than the consumer device 102, when the consumer actually makes a purchase. In any case, upon receiving the information, the promotion server 106 instantly targets offer providers who may be interested in the consumer and/or the examined or purchased item by analyzing the received information, the offer providers' promotional guidelines and/or data about the consumer. Upon identifying the offer providers, the promotion server 106 transmits the data related to the item and other data (e.g., the current weather conditions, the consumer's geographic location, etc.) thereto in real-time or at a time specified by the offer providers. The offer providers can then determine the timing and terms of their promotional offers. The offers may then be transmitted directly to the consumer mobile device 102 or via the promotion server 106. In some embodiments, occurrence of the triggering event results in an auction among offer providers, i.e., upon receiving notification of the consumer's action and the additional data they have requested, offer providers place their bids for the privilege of providing an offer to the consumer. The promotion server 106 determines one or more auction winners and the offer(s) provided by the auction winner(s) are then transmitted to the consumer. In still another embodiment, rather than notifying the offer providers of the consumer's action and waiting for them to provide offers or bids, the promotion server 106 selects one or more promotions based on the offer providers' promotional guidelines (stored in the promotions database), the consumer's action, the item associated therewith, and/or other data. The offer(s) are then communicated to the consumer device 102 on behalf of the promotion provider(s) for consumer approval/selection. In any case, the promotion server 106 may generate or retrieve a coupon or a link that directs the consumer to retrieve the offer(s) provided by the offeror(s). (The terms “offer provider” and “offerer” are herein used interchangeably.) In one implementation, the coupon is formatted as a code (such as, a barcode, an RFID code, or a QR code) and/or a signal (such as an NFC signal, an audio signal, or an infrared signal) readable by the reader 114 associated with the campaign server 110.

The payment processor 108 may be responsible for actually performing the payment transaction and, in some cases, for decrypting the payment token. For example, a so-called “direct” payment processor represents the financial-processing backend provider to credit-card issuers and payment services such as PAYPAL. An “indirect” payment processor is an independent entity processing transactions for multiple payment services and maintains its own records and data.

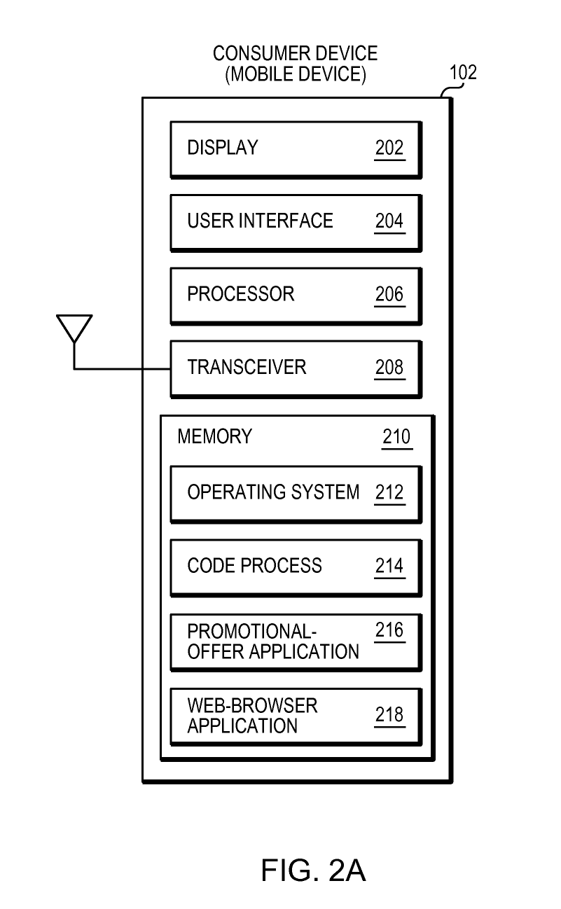

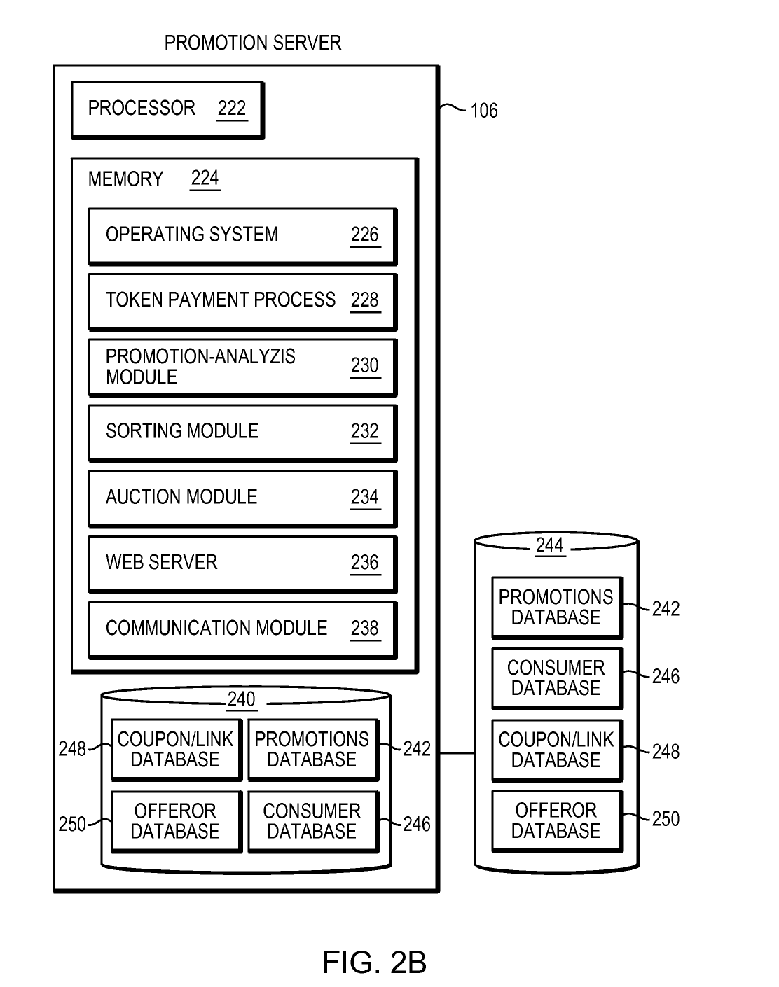

The mobile device 102 acts as a gateway for transmitting the consumer's data (e.g., the examined item information or a payment token) to the network 104. The mobile device 102 can support multiple communication channels for exchanging multimedia and other data with the promotion server 106, the campaign server 110, and other devices using a Wi-Fi LAN (e.g., IEEE 802.11 standard) for Internet access, a short-range Bluetooth wireless connection for point-to-point access, and/or an NFC channel for close-proximity access. Referring to FIG. 2A, in various embodiments, the mobile device 102 includes a conventional display screen 202, a user interface 204, a processor 206, a transceiver 208, and a memory 210. The transceiver 208 may be a conventional component (e.g., a network interface or transceiver) designed to provide communications with a network, such as the Internet and/or any other land-based or wireless telecommunications network or system, and, through the network, with the promotion server 106 and/or the campaign server 110. The memory 210 includes an operating system (OS) 212, such as GOOGLE ANDROID, NOKIA SYMBIAN, BLACKBERRY RIM or MICROSOFT WINDOWS MOBILE, and a token process 214 that implements the device-side functions for transmitting, receiving and/or generating the payment token. Additional transactional information may be embedded in the token process 214 for transmission through the network 104 for later processing on a backend server (e.g., the promotion server 106). In addition, the mobile device 102 may include a promotional-offer application 216 that enables the consumer to communicate the item of interest to the promotion server 106. For example, the consumer may utilize the promotional-offer application to scan an identifier (e.g., a barcode or a universal product code) located on the item, acquire an image of the item (by working together with a built-in camera) with the mobile device 102, and/or enter an identifier or keyword relating to the item (through a keypad or voice command implemented on the mobile device 102); information associated with the item of interest is then transmitted from the mobile device to the promotion server 106.

In some embodiments, the mobile device 102 includes a web-browser application 218 allowing the consumer to browse websites; the promotional-offer application 216 is configured to communicate the browsed items to the promotion server 106 and display one or more received promotional offers, if any, to the consumer via the user interface 204 as further described below. The promotional-offer application 216 and/or web-browser application 218 may be downloaded to the mobile device 102 via, for example, Intranet or other network connection or otherwise loaded from a computer readable medium, such as a flash memory device, memory card, etc. As used herein, the term “mobile device” used for transacting a mobile payment refers to a “smart phone” or tablet with advanced computing ability that, generally, facilitates bi-directional communication and data transfer using a mobile telecommunication network, and is capable of executing locally stored applications and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

Referring to FIG. 2B, in some embodiments, the promotion server 106 includes a processor 222, a memory 224 having an operating system (OS) 226, a token payment process 228, a promotion-analysis module 230, a sorting module 232, an auction module 234, a web-server block 236, a communication module 238 and a storage device 240. The token payment process 228 implements the server-side functions of transmitting, receiving, generating and/or decoding the payment token. Approaches for generating a secure payment token are described in, for example, U.S. Ser. No. 13/718,466, filed on Dec. 18, 2012, and Ser. No. 13/960,260, filed on Aug. 6, 2013, the entire disclosures of which are hereby incorporated by reference.

The offer provider may define its promotional guidelines by specifying a triggering event (e.g., when the consumer examines or purchases a specific item), alone or together with other targeting criteria (e.g., consumer demographics, transactional history, geographic proximity of the consumer to a location specified by the offer provider, weather conditions, etc.) to identify whether and when it wishes to receive notifications of a consumer's action. The promotional guidelines are stored in a promotions database 242 that resides in the local storage device 240 and/or an external mass-storage device 244 accessible to the promotion server 106, and may be withdrawn and/or modified as desired by the offer providers at any time. In some embodiments, when the consumer performs an action (e.g., examines an item of interest or requests payment approval involving an item sought to be purchased) that may be a triggering event defined by one or more offer providers, the promotion-analysis module 230 analyzes information about the item, the offeror-supplied triggering rules and targeting criteria, and/or the consumer's profile and records (containing historical, transactional and/or non-transactional data) stored in a consumer database 246 to determine when and which offer providers should be notified of the consumer's action. The identified offer providers may then finalize their offers and communicate them directly to the consumer mobile device 102 or indirectly via the promotion server 106. Thus, this approach allows the offerors to control the terms and timing of their promotions in order to accurately reflect the value of the consumer as well as the current economics of product promotion.

In other embodiments, the offer providers further register offer rules with the promotion server 106. These offer rules are stored in the promotions database 242, and, again, may be withdrawn and/or modified as desired by the offer providers. When receiving information from the consumer and/or a merchant POS system about items of interest or items sought to be purchased, the promotion server 106 analyzes the received data and stored promotional guidelines and offer rules to formulate at least one promotional offer, if one matching the stored criteria is available, in real-time. The offer(s) are then communicated to the consumer on behalf of the offer provider(s). When the item qualifies for more than one promotional offer, in one embodiment, the promotion-analysis module 230 ranks the offers based on, for example, the discount amounts, identifies the best deal (e.g., having the largest discount), and presents it to the consumer device 102 via the network 104. In another embodiment, the promotion-analysis module 230 transmits all available promotional offers to the consumer. The consumer approves and/or selects the desired offer(s) and communicates his decision to the promotion server 106. Upon receiving the communication from the consumer, and assuming it reflects acceptance of the offer, the promotion-analysis module 230 retrieves a coupon (or a link that directs the consumer to retrieve the offer(s)) from a coupon/link database 248 in the storage devices 240, 244 and transmits it to the consumer. The consumer may then present the coupon to a merchant during a transaction. Accordingly, the current invention provides the offer providers with effective consumer targeting based on their needs; this may result in a higher rate of offer redemption, thereby increasing sales traffic.

In one embodiment, the sorting module 232 classifies the consumer's records, including transactional and/or non-transactional data and the offeror-supplied promotional guidelines, into multiple classes prior to identifying one or more promotion offerors when receiving information from the consumer mobile device 102. Transactional classes may be drawn from earlier consumer purchases, and may correspond to categories of goods purchases by the consumer within a recent time period, and may also be sorted by attributes such as price, merchant, merchant location, redeemed offer, offer provider, etc. Non-transactional classes may include demographic data known about the consumer, (e.g., age, gender, address), geographic proximity of the consumer to a location specified by the promotion offeror. Additionally, non-transactional data may include environmental information, such as the weather conditions. Upon receiving information from the consumer or merchant POS system, the sorting module 232 assigns the received data to one or more classes. A comparison of the offeror-supplied promotional guidelines and the received information is then performed by the promotion-analysis module 230 on a class-by-class basis (with the various classes weighted, if desired) to simplify the process of targeting data transmissions to interested offerors and/or formulating offers.

In alternative embodiments, when receiving notification of the consumer's action (examination or purchase of an item), the auction module 234 supplies offer providers with the received information and any additional data specified by offer providers to allow them to bid, in real-time, for the privilege of providing an offer to the consumer. In such embodiments, data reflecting the examined/purchased item (e.g., name and price), and optionally transactional and/or non-transactional data for the consumer, are transmitted to offer providers registered with the promotion server 106. Interested offer providers submit bids to the promotion server 106, which reflect how much they are willing to pay to have their offers presented to the consumer; this amount may be staged to reflect, for example, a first fee for transmission of the offer and a second fee if the consumer actually redeems the offer. The first fee can be tiered so that the offer provider has the option of bidding a higher amount for exclusivity, i.e., to preclude other offers from being simultaneously provided to the consumer. The auction module 234 assesses the bids as well as item-level and/or source-level conflicts (to prevent two offers for competing items from being simultaneously present to the consumer, for example, or alternatively, to search for and affirmatively provide competitive offers). Depending on the nature of the offer(s), they may be redeemed immediately by the consumer, in which case a transaction request is directly sent from the consumer mobile device 102 to the promotion server 106 for payment, and/or may simply be supplied to the consumer's mobile device for future use.

More specifically, in auction implementations, the auction module 234 provides information associated with the examined/purchased item and/or the consumer's records to the offerors' campaign servers 110, which, in turn, place their bids associated with providing promotional offers for the examined/purchased item. The auction module 234 determines at least one auction winner based on, for example, the provided discount amount. The offer(s) from the auction winner(s) are then transmitted to the consumer mobile device 102 directly from the auction winner(s), or in some embodiments, indirectly via the promotion server 106. Records associated with the offer providers may be stored in an offeror database 250 in the storage devices 242, 244. Conducting the auction during the item examination/purchase allows the offerors to modify their offers and select a bid amount that reflects current business conditions and strategic priorities. Although the discussion herewith focuses on auctions including promotional offers related to the examined/purchased item, bids may contain promotions for future purchases. In one embodiment, only the bid from the bid winner is transmitted to the consumer. In another embodiment, some or all bids relating to future purchases are passed on to the consumer.

In various embodiments, after the consumer redeems the offer(s), the promotion-analysis module 230 analyzes the completed transactional details (e.g., examined item, purchased item, transaction amount, transaction date/time, merchant type, etc.), the offer(s) approved/selected by the consumer, and/or the consumer's records to identify offers for items of potential interest to the consumer based on the offeror-supplied promotional guidelines. The promotion-analysis module 230 then formulates another promotional offer(s) and transmits it to the consumer as an incentive for future purchases. Again, the offer(s) may be transmitted to the consumer device 102 in the form of, for example, a coupon or a link. In another embodiment, the completed transactional details and the consumer's data are transmitted to interested offer providers for analysis, thereby enabling them to modify the targeting criteria and/or offers in the future.

The web-server block 236 enables web-based communication with the mobile device 102, the payment server 108, and the campaign server 110, and can be a conventional web-server application executed by the processor 222. The communication module 238 may be a conventional component (e.g., a network interface or transceiver) designed to provide communications with a network, such as the Internet and/or any other land-based or wireless telecommunications network or system, and, through the network, with the mobile device 102. The databases 242, 246, 248, 250 are responsive to queries from the promotion-analysis module 230, the sorting module 232, and the auction module 234.

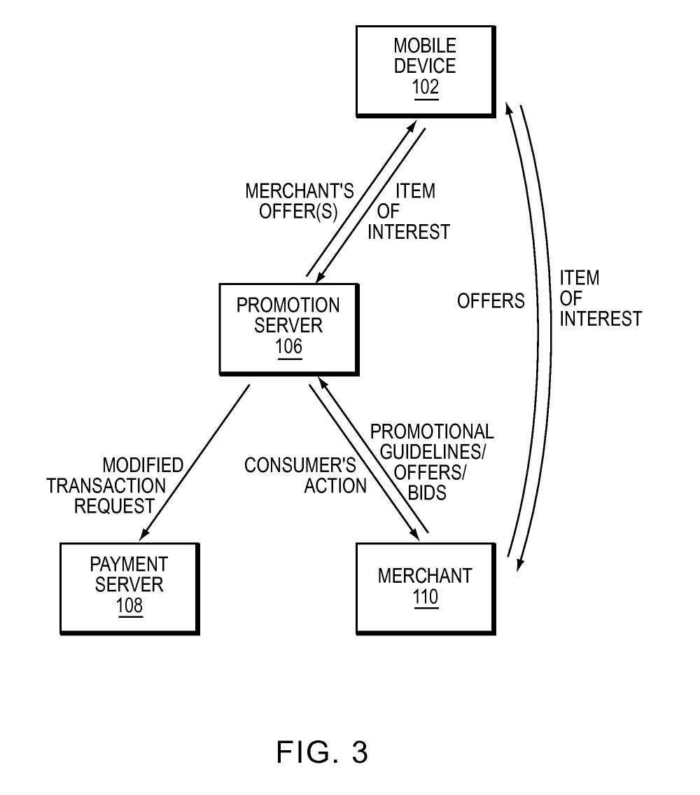

Referring to FIG. 3, in a typical operation, a promotion offeror interested in providing promotional offers for goods or services to the consumer may register an account with the promotion server 106 via its campaign server 110 to enable the promotion offeror to receive notifications of the consumer's actions and selectively provide promotions to the consumer thereafter. The offeror may provide the promotion server 106 with its promotional guidelines specifying a triggering event and/or targeting characteristics (e.g., the consumer's transactional history, demographics, reviews or posts on social media sites, groups or clubs with which the consumer is associated, weather conditions, etc.) to define whether and when the offeror wishes to receive notifications of the consumer's action. For example, a grocery merchant may be interested in grocery items only; the triggering event thus occurs only when the consumer examines a grocery item on store shelves or on a webpage. Therefore, when the consumer's action is transmitted from his mobile device 102 to the promotion server 106, the promotion server 106 first queries the promotions database 242 and analyzes the consumer's action and information associated therewith (e.g., data identifying the consumer's queried item) to determine whether the triggering event is satisfied. If so, notification of the consumer's action and data identifying the item examined by the consumer, the consumer's records and/or other data are provided to the promotion offeror, which, in turn, determines whether, when and what promotion it is willing to offer to the consumer based on the received information. If the promotional guidelines include targeting characteristics, the promotion-analysis module 230 further analyzes the received data and/or the consumer's records in greater detail to determine whether the targeting characteristics are satisfied.

Therefore, upon receiving the information transmitted from the mobile device 102, the promotion server 106 may first identity the consumer by, for example, detecting the cellular phone number, cellular telephone electronic serial number (ESN), International Mobile Equipment Identity (IMEI) code, or 802.15 (Bluetooth) MAC address associated with the mobile device 102 and matching the information to the consumer's records stored in the database 246. The promotion server 106 then queries the consumer's profile and records stored in the consumer database 246 and/or other data such as weather conditions to determine whether the targeting characteristics are satisfied; notification of the consumer's action is supplied to the offeror only when a defined triggering event occurs and the targeting characteristics are satisfied. For example, a local merchant may wish to target consumers residing in the same state rather than a tourist visiting from another state. In that case, when two consumers—one local and one a tourist—both scan the same item in the same store and trigger the event set by the merchant, it may be that only one of those consumers (in this case, the local consumer) will satisfy the criteria supplied by the local merchant. As a result, only the local consumer's action is transmitted to the local merchant, who, in turn, only learns of the triggering event—in this case, the consumer's scan of the item—when the target criteria are met. In addition, while some offer providers may select consumer examination of an item as a triggering event, others may prefer not to send offers until the consumer actually requests payment approval for a purchase, in which case checkout is the triggering event. And again, upon receiving the item data and the consumer's information during checkout, the offer providers can decide the terms and timing of the promotions that they are willing to offer the consumer.

The offer providers may communicate their offers directly to the consumer mobile device 102 or indirectly via the promotion server 106. The offers may be simple text messages; if the consumer chooses to redeem an offer, the campaign server 110 associated with the offeror or the promotion server 106 may retrieve a coupon (or a link that directs the consumer to the offer) from a coupon/link database. Alternatively, the offers may be in the form of a coupon link that the consumer can present to the merchant upon checkout. In some embodiments, the offer providers may directly receive notification of the consumer's action via the promotional-offer application 216 in the mobile device 102. For example, when the consumer browses an item on a webpage, the promotional-offer application 216 may be configured to transmit the browsed items directly to the campaign server 110, which then determines whether and what promotions it is willing to offer. The offers and their associated items may be automatically added into the consumer's shopping cart on the offeror's webpage or, alternatively, may be listed in a new window in the consumer mobile device 102.

In various embodiments, occurrence of a triggering event and/or satisfaction of the targeting characteristics results in an auction among offer providers, i.e., upon receiving notifications of the consumer's action and the additional data that the offerors have requested, offer providers may place bids for the privilege of providing an offer to the consumer. The auction module 234 determines one or more auction winners based on auction rules; a promotional offer(s) provided by the auction winner(s) are then transmitted to the consumer. The auction rules may include, for example, the discount amount, any item-level or seller-level conflict between the offers (e.g., offers for the same type of items from competing merchants), the likelihood of offer redemption, the likelihood of affecting the consumer's future purchases, benefits accruing to the consumer and/or the offer providers, the geographic proximity between the consumer and the offer providers, etc. Because the consumer's information is provided to offerors based on their targeting criteria and the offers provided to the consumer are from the auction winner(s), the provided offers may be more attractive to the consumer and therefore more likely to be redeemed.

In some embodiments, the promotional guidelines supplied by the offer providers may further specify promotional rules that identify recipients for various types of promotions associated with specific sale items (goods or services). This allows the promotion server 106 to autonomously identify promotions applicable to these recipients and directly transmit the offers to them on behalf of the offer provider when the consumer's action and the item associated therewith satisfy the provider's promotional rules. In addition, for each offer, the offer provider may make the offer flexible and responsive to features of the triggering transaction. For example, the promotional rules may permit a range of discount percentages, a duration of the promotional offer available to the consumer, adjustment of the offer with time, and/or combinability with other offers that are implemented in response to conditions selected by offer providers and thereby incorporated into the promotional rules. For example, a local recreational store may offer a 10% to 20% discount to residents who currently live in the same state; members of the store may receive a larger discount while non-members receive a smaller discount. In addition, the recreational store may offer an extra 5% off on winter gear to all consumers if it has snowed more than 5 inches in the area in the past week, or to consumers who have purchased winter gear from a competing store. Thus, due to differences in the consumer's current residence, weather conditions and/or transaction history, the promotion server 106 may provide different offers to different consumers or different offers to the same consumer at different times.

The promotional offers may be the offer providers' normal offers reflecting their business strategies or the subject of a separate arrangement with the party hosting the promotion server 106. In some embodiments, the offer provider pays monthly fee in exchange for the promotion server 106 transmitting his offers to the consumers. The provided discounts, and, in some embodiments, the fee paid by the offer provider may be based on, for example, the number of times offers are delivered to the consumer, the number of hits on the offers, the number of consumers who ultimately redeem the offer, the ranking of the offers, etc. In addition, the promotional offers need not be stored on the promotion server 106, but may instead reside on the offeror's campaign server 110 to enable the offeror to change the terms of the offer at will in real-time. For example, the promotions database 242 may store an Internet address associated with an offer, and when its criteria or rules are satisfied, the promotion server 106 retrieves the most current version of the offer from the campaign server 110 using the Internet address, and thereupon provides this offer to the consumer whose action caused the criteria/rules to be satisfied.

Prior to or during a transaction, the consumer may obtain information about an item of interest by, for example, acquiring an image of the item, scanning a barcode affixed to the item, and/or entering an item name using his mobile device 102, which, in turn, transmits the obtained item information to the promotion server 106 (or, in some embodiments, campaign server 110). Alternatively, the promotional-offer application 216 may monitor the items browsed by the consumer and transmit this information to the promotion server 106. In another embodiment, when the consumer actually makes a purchase, the merchant POS terminal transmits the information about items to be purchased to the promotion server 106 (or campaign server 110). In any case, upon receiving the information, the promotion server 106 first identities the consumer using information associated with his mobile device 102, and subsequently queries promotional or other targeting criteria stored in the promotions database 242 and/or consumer records stored in the consumer database 246 to determine whether the consumer and/or the item of interest qualifies for a promotional offer; if so, the promotion server 106 formulates the offer based on the offeror-supplied promotional rules. For example, the consumer may examine a pair of ski gloves, an action that results in transmission of consumer and item identifiers to the promotion server 106. The promotion server, in turn, identifies the discounts provided by the local recreational store as described above. The promotion server 106 analyzes the consumer's records to determine whether he resides in the same state as the store and whether he is a member thereof. In addition, the promotion server 106 searches for weather conditions over the past week to determine whether the consumer can take advantage of an extra discount (assuming the weather conditions are satisfied). The promotion server 106 then formulates, for example, two offers, one with 15% discount available and the other with 25% discount available if he joins a membership program with the store, and transmits them to the consumer. If the consumer claims one of the offers, the promotion server 106 retrieves a coupon/link associated with the offer from the database 248 and transmits it to the consumer device 102. Again, the coupon may be formatted as a code and/or a signal readable to a merchant system. Because the offers are provided based on the offeror-supplied promotional rules and the consumer personal records, each consumer can beneficially receive customized offers in which he is more interested and more likely to claim/redeem. The current invention thus provides a consumer-targeting approach that can effectively deliver suitable promotional offers to the consumers on an individual level. In addition, because the offers are formulated by the promotion server 106, which maintains and stores the consumer's profile, the consumer's information is shielded from the merchants for security/privacy purposes.

Although the discussion herewith focuses on promotions provided upon receiving a consumer's action, offers for items in which the consumer may be interested may be delivered to the consumer based on time of day or other targeting criteria. For example, during lunch time, the promotion server 102 may detect the consumer's current location using, for example, a global-positioning-system (GPS) signal transmitted from the mobile device 102. The promotion server 102 then searches lunch deals provided by merchants located in close proximity to the consumer, formulates at least one offer based on the offeror-supplied criteria, and transmits the offer(s) to the consumer. In another example, on a rainy day, the promotion server 102 may search for rain-gear offers provided by merchants located in the consumer's area and transmit available offers to the consumer. Accordingly, the promotion server 106 may use the consumer's records (including transactional and non-transactional data) and/or other data (e.g., weather conditions) to formulate one or more promotional offers for items that may be of timely interest to the consumer, based on the offeror-supplied criteria; the offers are then delivered to the consumer with or without consumer's action.

The consumer's transactional data may be obtained from previous transactions handled by or informationally accessible to the promotion server 106, including purchased items (i.e., goods and/or services), transaction amounts and time, names or merchant category codes of the involved merchants, account numbers, approval or denial information, etc. The non-transactional data is any data not directly derived from previous transactions but relevant to the consumer's behavior or status. For example, the non-transactional data may include membership status in various organizations (e.g., an animal-rights organization, Sierra Club, Humane Society, National Rifle Association, etc.), a medical history, habits, preferences and dislikes, demographics, geographic proximity of the consumer to a location specified in advance by the offeror, etc.

In some embodiments, consumers register with the promotion server 102 in order to receive offers, and provide this information directly at that time. Alternatively or in addition, information about the consumer may be collected from social media sites using the web-server block 236 or communication module 238. The social media sites may include or communicate with collaborative projects (e.g., WIKIPEDIA), blogs or microblogs (e.g., TWITTER and PINTEREST), content communities (e.g., YOUTUBE), social networking sites (e.g., FACEBOOK and GOOGLE+), online newspapers, event calendars, message boards, or any one, or combination of, network-based applications utilized by the consumer and which provide useful consumer-specific information for analysis of the offer applicability. Information can be accessed or retrieved from the social media sites in various ways. For example, web crawlers may be used to access social media postings and analyze entries or textual postings for relevant information to glean the information in an automated fashion (see, e.g., U.S. Pat. No. 8,352,406). In addition, the promotion server 106 may acquire the consumer's information by subscribing to various media sites using well-known approaches, such as really simple syndication (RSS) feeds, API accesses, etc.; see, e.g., U.S. Ser. No. 14/107,677, filed on Dec. 16, 2013, the entire disclosure of which is hereby incorporated by reference.

The offers available to the consumer may be exclusive or combinable. In one embodiment, the offerors determine whether their offers are combinable with other offers of their own and/or offers provided by other offerors, and may pay a premium to keep their offers exclusive; these decisions are stored in the promotions database 242. In another embodiment, the decision is made by the promotion server 106 based on, for example, the discount amount, conflicts between the offers (e.g., offers for the same type of items from different manufacturers), the likelihood of offer redemption, the likelihood of affecting the consumer's future purchases, and/or the benefits to the consumer, the offeror, and/or the party hosting the promotion sever 106. For example, all offers having no conflicts (e.g., involving unrelated types of items) may be transmitted to the consumer. If there is a conflict among different offers (e.g., the same type of product from different merchants), the promotion server 106 may transmit only the offer giving a bigger discount to the consumer. In some embodiments, the promotion-analysis module 230 assigns a ranking score to each available offer based on, for example, the geographic proximity between the consumer and the offerors, the popularity of the offers, the ratings and reviews of the offerors by other consumers, discounted amounts, and/or the frequencies that the connections of the consumer on social media sites have mentioned about the offerors (approaches for analyzing social-connection information for each consumer can be found in, e.g., U.S. Ser. No. 13/901,344, filed on May 23, 2013, the entire disclosure of which is hereby incorporated by reference). The promotion server 106 may then transmit one or more offers having the highest ranking scores to the consumer. Alternatively, the consumer may define rules to select/determine how she likes to rank the available offers. After the promotion-analysis module 230 ranks the offers based on the consumer-supplied rules, again, offers having the highest ranking scores may be delivered to the consumer.

In addition, offers delivered to the consumer may be changed in accordance with her behavior. For example, the promotion-analysis module 230 may adjust the ranking score to each available offer based on the consumer's records, including, for example, categories of items purchased, categories of promotions offered and redeemed in the past, the consumer's reviews of the items and offerors, the consumer's hobbies, preferences and dislikes, etc. The promotion-analysis module 230 may periodically examine consumer transactional and non-transactional behavior to adjust the rankings and the associated scores. For example, if the consumer claims and/or redeems a specific offer, a higher ranking score may be assigned to the same or similar offer for the same item and/or from the same offer provider in response to the consumer's next action. On the other hand, if the consumer writes a negative review about his experience with the offeror, lower ranking scores are assigned to future offers provided by the same provider. In another example, a merchant may offer a greater discount to a consumer who has not purchased anything therefrom for a while or rewards a loyal consumer with an additional promotion; the bigger discount or additional promotion then has a higher ranking score assigned thereto. Because the ranking score can be varied based on the consumer's behavior in real time, the promotion server 106 may timely provide customized offers to each individual consumer.

While the consumer may receive the selected offers and present them to a merchant system during a transaction, the consumer may not even be required to receive the offers for redemption. For example, when the consumer claims an offer, the promotion server 106 may directly transmit a notification message to the merchant indicating that the offer has been claimed; the claimed offer may be stored in the consumer database 246 associated with the consumer's records. During a transaction, the consumer may present his payment token to the merchant as usual; upon receiving a transaction request from the merchant system, the promotion server 106 may identify the consumer, the item sought to be purchased, the merchant and the claimed offer, and redeem the claimed offer automatically. In other embodiments, when the consumer claims an offer, the promotion server 106 automatically directs the consumer to the offer provider's web pages with the item sought to be purchased in a shopping cart and a promotion code automatically filled in; the consumer may redeem the offer by simply pressing a “check-out” button. Again, the promotional offers may be provided by any party, such as the product manufacturer, advertiser, the merchant, other marketplace participant upstream from the merchant, or any party interested in providing promotions to the consumer directly or indirectly via the promotion server 106.

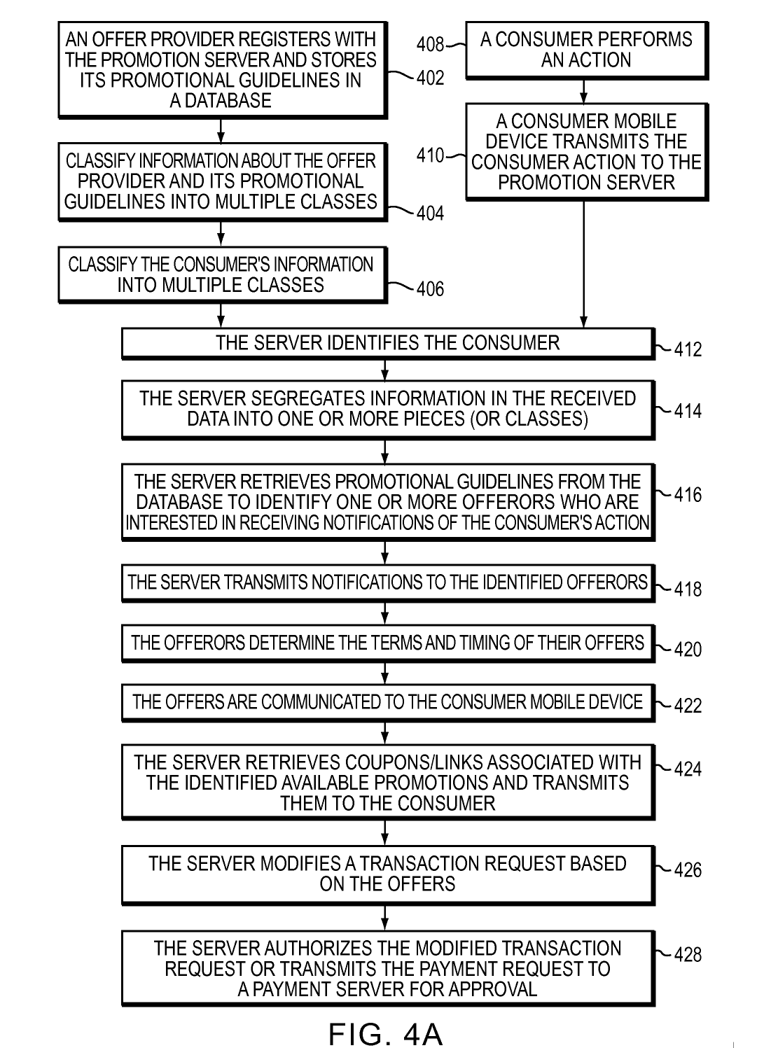

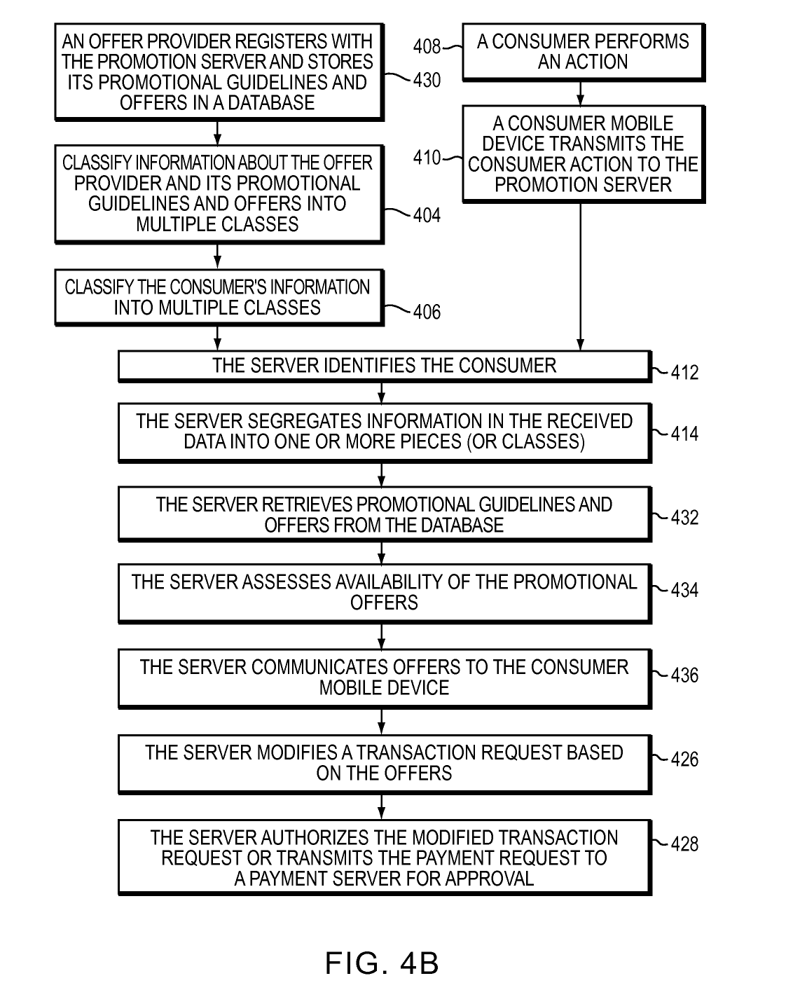

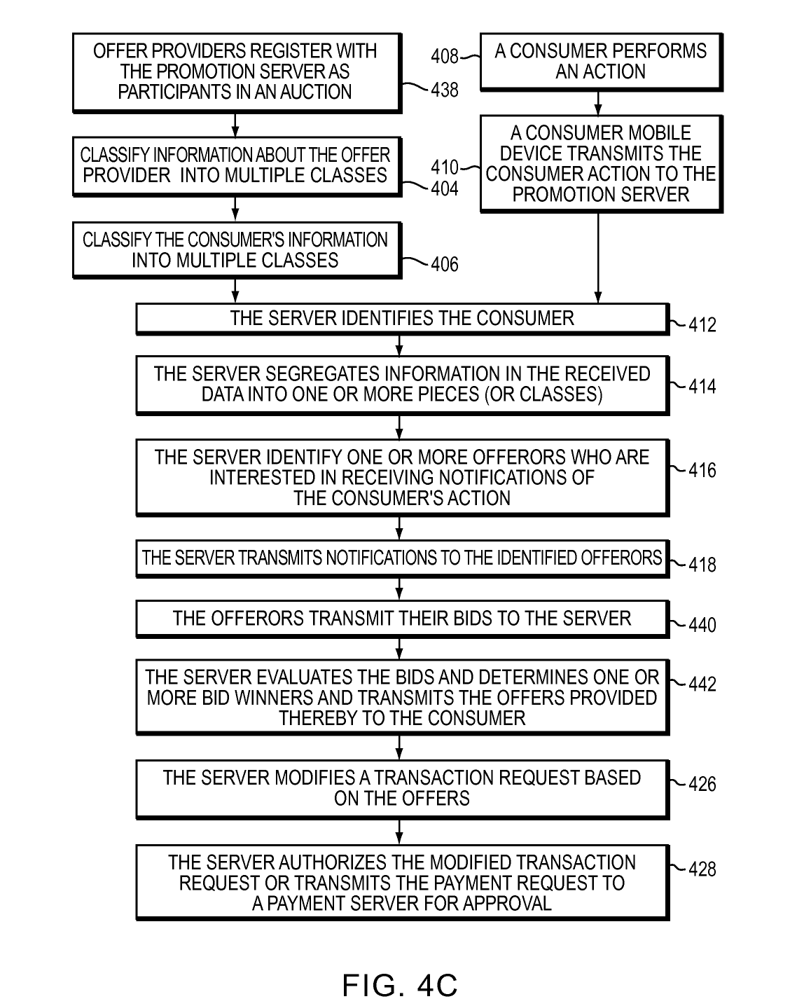

Representative methods for merchants to provide promotional offers to consumers in accordance with embodiments of the current invention are shown in FIGS. 4A-4C. Referring to FIG. 4A, a promotion offeror interested in offering promotions to consumers may register with the promotion server 106 and store the promotional guidelines, such as triggering rules and promotional criteria, in the promotions database 240 (step 402). In some embodiments, information about the offeror and its promotional guidelines is classified into multiple classes (step 404). In addition, the consumer's information is classified into multiple classes (step 406). When the consumer performs an action (e.g., examines or purchases an item), the consumer mobile device 102 transmits the consumer action to the promotion server 106, or in some embodiments, directly to the campaign server 110 associated with the offeror (step 408). Upon receiving the consumer action, the promotion server 106 identifies the consumer based on information associated with the mobile device 102 (step 410). In one embodiment, the promotion server 106 segregates information in the received data into one or more pieces (or classes) (step 412) and retrieves promotional guidelines from the database 242 (step 414). The promotion server 106 can then apply the promotional guidelines to the information about the consumer and the item-level data to identify one or more offerors who are interested in receiving notifications of the consumer's action and providing offers to the item/consumer (step 416). For example, if the triggering rules and/or targeting criteria set forth by the offerors are satisfied, the promotion server 106 transmits notifications thereto (step 418). Upon receiving the information, the offerors determine whether, when and what offers they are willing to provide (step 420). These offers are then communicated directly to the consumer mobile device 102 or indirectly via the promotion server 106 (step 422). In one embodiment, the promotion server 106 retrieves one or more coupons/links associated with the offers and transmits the coupons/links to the consumer for redemption (step 424). When the consumer redeems the offers, the promotion server 106 modifies a transaction request submitted from the merchant (e.g., reducing the price) based thereon (step 426) and passes the modified payment data to the payment processor 108 for authorization, or in some embodiments, approves the transaction directly (step 428).

Referring to FIG. 4B, in some embodiments, the promotion offerors further store promotional offers together with the triggering rules and promotional criteria in the promotion server 106 (step 430). Again, information about the offerors, their promotional guidelines and the consumer is classified into multiple classes as described in steps 404-406. In addition, when receiving information from the consumer mobile device 102, the promotion server 106 processes the received data in a similar way as described in steps 408-414. The promotion server 106 then retrieves promotional guidelines from the promotions database 242 (step 432) and assesses the availability of promotional offers based on the offeror-supplied triggering rules and promotional criteria (step 434). Upon identifying one or more promotions, the promotion server 106 retrieves the promotional offers and communicates them to the consumer on behalf of the offerors (step 436). When the consumer redeems the offers, the promotion server 106 processes a transaction request submitted by the merchant as described in steps 426-428.

Referring to FIG. 4C, in various embodiments, the offer providers sign up on the promotion server 106 as participants in an auction (step 438). Upon receiving notifications of the consumer action and/or other requested data from the promotion server 106, the offer providers utilize the consumer records and item data in identifying prospects for promotions and transmit their bids to the promotion server 106 for the privilege of providing offers to the consumer (step 440). The promotion server 106 then evaluates the bids and determines one or more bid winners and transmits to the consumer the offers corresponding thereto (step 442). Again, the promotion server 106 may process a transaction request submitted by the merchant as described in steps 426-428 when the consumer redeems the offers.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. Those skilled in the art will readily appreciate that all configurations described herein are meant to be exemplary and that the actual configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “user device,” “mobile,” “communication device,” and similar terminology, refer to a wireless device (e.g., cellular phone, smart phone, computer, PDA, set-top box, Internet Protocol Television (IPTV), electronic gaming device, printer, and so forth) utilized by a user of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The processor 206, 222 that execute commands and instructions may be a general purpose computer, but may utilize any of a wide variety of other technologies including a special purpose computer, a microcomputer, minicomputer, mainframe computer, programmed microprocessor, micro-controller, peripheral integrated circuit element, a CSIC (customer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, code or process) include machine instructions for a programmable processor, and can be implemented in a high-level procedural and/or object-oriented programming language, and/or in assembly/machine language.

The storage devices 240, 244 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the UNIX operating system, the LINUX operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

The storage devices 240, 244 may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described herein. For example, various forms of the flows shown above may be used, with steps re-ordered, added, or removed. Accordingly, other implementations are within the scope of the following claims.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of electronically providing a consumer with targeted promotional offers for goods or services, the method comprising steps of, at a server computer comprising a processor:
electronically storing, by the processor in a database, a plurality of records each comprising data identifying at least one item and one or more trigger rules;
electronically storing, by the processor in a database, a plurality of consumer records each comprising data relating to the identity and at least one attribute of a consumer;
electronically receiving via a communication network notification indicative of an action by a consumer, the notification comprising data identifying the consumer and at least one item;
automatically identifying, by the processor, at least one promotion offeror by querying the database using the received item data; and
if the received item data and consumer data satisfies a trigger rule, causing, by the processor, transmission via a communication network of data comprising item identification to the at least one identified promotion offeror at an offeror device;
electronically transmitting, by the at least one identified promotion offeror, at least one promotion to a mobile device associated with the consumer, the at least one promotion being redeemable via the mobile device by presenting a token at a retail point-of-sale device.

2. (canceled)

3. The method of claim 1, wherein the action is scanning, by the consumer, an item using a mobile phone of the consumer.

4. The method of claim 1, further comprising identifying the consumer based on information associated with the mobile device and providing data characterizing the consumer to the at least one identified promotion offeror.

5. The method of claim 1, wherein the data comprising item identification further comprises non-transactional information.

6. The method of claim 5, wherein the non-transactional information includes at least one of (i) weather conditions, (ii) geographic proximity of the consumer to a location specified in advance by the at least one identified promotion offeror, or (iii) demographic information characterizing the consumer.

7. The method of claim 5, wherein the non-transactional information comprises information associated with a mobile device of the consumer, the device information itself comprising at least one of a cellular phone number, a cellular telephone electronic serial number (ESN), an International Mobile Equipment Identity (IMEI) code, or an 802.15 (Bluetooth) MAC address.

8. The method of claim 1, wherein the data comprising item identification further comprises transactional information.

9. The method of claim 8, wherein the transactional information comprises a past purchasing history of the consumer.

10. The method of claim 1, wherein the action comprises at least one of acquiring, by a mobile phone of the consumer, at least one of an image, a barcode, a universal product code, an identifier, or a keyword relating to the item.

11. The method of claim 1, wherein the action comprises presentation, by the consumer, of the item for checkout.

12. The method of claim 1, further comprising receiving, at a promotion server, bids from a plurality of promotion offerors following transmission of the data to them.

13. The method of claim 12, further comprising identifying a winning bid and transmitting at least one offer associated therewith to a mobile device associated with the consumer.

14. The method of claim 13, wherein the at least one offer is transmitted by the promotion server.

15. The method of claim 13, wherein the at least one offer is transmitted by a source of the winning bid.

16. A method of electronically providing a consumer with targeted promotional offers for goods or services, the method comprising steps of, at a server computer comprising a processor:
electronically storing, in a database, a plurality of records each comprising data identifying at least one item, one or more trigger rules, and one or more promotions;
electronically storing, in a database, a plurality of consumer records each comprising data relating to the identity and at least one attribute of a consumer;
electronically receiving via a communication network notification indicative of an action by a consumer, the notification comprising data identifying the consumer and at least one item;
automatically identifying at least one promotion by querying the database using the received item data; and
if the received item and consumer data satisfies a trigger rule, causing electronic transmission via a communication network to the consumer at a consumer device of the at least one identified promotion;
wherein the promotion is electronically transmitted to a mobile device of the consumer and is redeemable via the mobile device by presenting a token at a retail point of sale device.

17. (canceled)

18. The method of claim 16, wherein upon identifying a plurality of promotions, assigning each of the plurality of promotions a ranking score and transmitting only some of the plurality of promotions based on the ranking scores thereof.

19. The method of claim 18, wherein the ranking scores are assigned based on at least one of (i) a discount amount, (ii) geographic proximity between the consumer and offer providers, (iii) a likelihood of offer redemption, (iv) a likelihood of affecting the consumer's future purchasing behavior, (v) popularity of the offers, (vi) ratings and reviews of offer providers by other consumers, or (vii) frequencies that connections of the consumer on social media sites have mentioned offer providers.

20. The method of claim 16, further comprising:
classifying the trigger rules and records associated with the consumers into a plurality of classes;
classifying data identifying the item into at least one class; and
computationally determining applicability of the trigger rules based at least in part on the at least one identified class of data.

21. The method of claim 16, further comprising:
directing the consumer to an offer provider's web page associated with the at least one transmitted promotion;
adding the item of interest in a shopping cart; and
entering a promotion code on the offer provider's web page.

22. A server computer for electronically providing a consumer with targeted promotional offers for goods or services, the server computer comprising:
an item database for storing a plurality of records, each comprising data identifying at least one item and one or more trigger rules;
a consumer database for storing a plurality of consumer records each comprising data relating to the identity and at least one attribute of a consumer;
a communication module; and
a processor configured to:
electronically receive, via the communication module from a merchant device over a communication network, notification indicative of an action by a consumer, the notification including data identifying the consumer and at least one item;
automatically and computationally identify at least one promotion offeror by querying the database using the received item data;
if the received item data and consumer data satisfies a trigger rule, cause transmission via a communication network of data comprising item identification to the at least one identified promotion offeror at an offeror device; and
transmit at least one promotion to a mobile device associated with the consumer, wherein the promotion is redeemable via the mobile device by presenting a token at a retail point of sale device.

23. (canceled)

24. The server of claim 22, wherein the processor is further configured to identify the consumer based on information associated with the mobile device and provide data characterizing the consumer to the at least one identified promotion offeror.

25. The server of claim 22, wherein the data comprising item identification further comprises non-transactional information, the non-transactional information including at least one of (i) weather conditions, (ii) geographic proximity of the consumer to a location specified in advance by the at least one identified promotion offeror, or (iii) demographic information characterizing the consumer.

26. The server of claim 22, wherein the data comprising item identification further comprises transactional information, the transactional information comprising a past purchasing history of the consumer.

27. The server of claim 22, wherein the action comprises at least one of acquiring, by a mobile phone of the consumer, at least one of an image, a barcode, a universal product code, an identifier, or a keyword relating to the item.

28. The server of claim 22, wherein the processor is further configured to electronically receive bids from a plurality of promotion offerors following transmission of the data to them.

29. The server of claim 28, wherein the processor is further configured to computationally identify a winning bid and transmit at least one offer associated therewith to a mobile device associated with the consumer.

30. A server computer for electronically providing a consumer with targeted promotional offers for goods or services, the server computer comprising:
an item database for storing a plurality of records, each comprising data identifying at least one item, one or more trigger rules, and one or more promotions;
a consumer database for storing a plurality of consumer records each comprising data relating to the identity and at least one attribute of a consumer;
a communication module; and
a processor configured to:
electronically receive, via the communication module from a merchant device over a communication network, notification indicative of an action by a consumer, the notification including data identifying the customer and at least one item;
automatically and computationally identify at least one promotion by querying the database using the received item data; and
if the received item data and consumer data satisfies a trigger rule, cause electronic transmission via a communication network to the consumer at a consumer device of the at least one identified promotion; and
electronically transmit at least one promotion to a mobile device associated with the consumer, wherein the promotion is redeemable via the mobile device by presenting a token at a retail point of sale device.
